(19) United States
(12) Patent Application Publication
(10) Pub. No.: US 2009/0060412 A1
(43) Pub. Date: Mar. 5, 2009

(54) High-Power High-Frequency Photodetector

(75) Inventors: Jianxiao Chen, North Billerica, MA (US); Charles Cox, Carlisle, MA (US)

Correspondence Address: RAUSCHENBACH PATENT LAW GROUP, LLC, P.O. BOX 387, BEDFORD, MA, 01730, US

(73) Assignee: PHOTONIC SYSTEMS, INC., Billerica, MA (US)

(21) Appl. No.: 12/202,175

(22) Filed: Aug. 29, 2008

Related U.S. Application Data
(60) Provisional application No. 60/966,717, filed on Aug. 30, 2007.

(51) Int. Cl. G02F 1/295; G02B 6/00

(52) U.S. Cl. 385/10; 385/12

(57) ABSTRACT

A photodetector includes an optical distribution device having an optical input that receives an input optical signal and an optical waveguide grating coupler that converts the input optical signal from a longitudinal direction radiation mode to a surface-emitted radiation mode and that distributes the optical signal along a length of the optical waveguide grating coupler and emits the distributed optical signal from the surface. An optical detector includes an optical input that is positioned to receive the distributed optical signal emitted from the optical distribution device along a length the optical waveguide grating coupler. The optical detector generates a traveling wave RF signal. The optical distribution device reduces the optical power density of the input optical signal, thereby avoiding local saturation and damage to the optical detector.

### RELATED APPLICATION SECTION

This application is a non-provisional patent application that claims priority to U.S. Provisional Patent Application Ser. No. 60/966,717, filed Aug. 30, 2007, entitled “Ultra-High Power, High Frequency, High Linearity Photodetector.” The entire specification of U.S. Provisional Patent Application Ser. No. 60/966,717 is incorporated herein by reference.

### BACKGROUND OF THE INVENTION

Some modern communications systems require photodetectors that can simultaneously achieve high power, high optoelectronic responsivity, high bandwidth, and high linearity. For example, a typical system may require a photodetector that can accommodate an injection optical power of 1.5 W with a responsivity of 0.7 A/W, a 3-dB bandwidth of 20 GHz, and a third order intercept point of +75 dBm. Known surface-normal or waveguide edge-illumination photodetectors generally cannot meet these goals simultaneously because of certain performance compromises that are inherent to these detectors. For example, a surface-normal photodetector can be designed to detect high optical power if a large detection area is provided to reduce the local power density and thereby prevent local saturation and/or local damage. However, such large detection areas increase the capacitance of these detectors and, therefore, increase the associated RC time constant, thus limiting the bandwidth of the detector.

Recently, traveling-wave photodetectors have been proposed and demonstrated to solve this RC time constant response limit using coplanar microwave traveling-wave transmission lines that have distributed, rather than lumped element, capacitance. Conventional traveling wave photodetectors monolithically fabricated in III-V compound materials also have some disadvantages. First, the optical waveguide and the traveling wave transmission lines are coupled with one another. This coupling makes it difficult to match the RF guided-wave velocity of the traveling wave transmission lines to the velocity of the light in the optical waveguide.

Second, the optical transmission waveguide and the optical detection layer are coupled with one another. The variation of the local photocurrent density and of the local temperature inside the detection layer will feedback into and change the transmission properties of the optical waveguide. This variation of the local photocurrent density and of the local temperature inside the detection layer also causes some detector nonlinearities. In the other words, the light is distributed through a “hot” waveguide which varies with the injection optical power level due to the carrier accumulation effect.

Third, the distribution profile of the light along the waveguide has an exponential decay, and thus has the highest local optical density at the very beginning section proximate to the input port. The beginning section can be totally saturated or even damaged when high optical powers are detected which are on the order of about 1.5 Watts. Finally, the waveguide propagation loss of many photodetector materials, such as III-V materials, is relatively high and, therefore, cannot support long propagation distance.

### BRIEF DESCRIPTION OF THE DRAWINGS

The aspects of this invention may be better understood by referring to the following description in conjunction with the accompanying drawings. Identical or similar elements in these figures may be designated by the same reference numerals. Detailed description about these similar elements may not be repeated. The drawings are not necessarily to scale. The skilled artisan will understand that the drawings, described below, are for illustration purposes only. The drawings are not intended to limit the scope of the present teachings in any way.

FIG. 1 is a diagram of one embodiment of a high-power, high-speed optical detector that includes separate optical distribution and optical detection devices according to the present invention.

FIG. 2 is a graph of calculated saturated photocurrent as a function of device length for a high-power, high-speed optical detector according to the present invention.

### DETAILED DESCRIPTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be understood that the individual steps of the methods of the present invention may be performed in any order and/or simultaneously as long as the invention remains operable. Furthermore, it should be understood that the apparatus and methods of the present invention can include any number or all of the described embodiments as long as the invention remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

The invention relates generally to optoelectronic devices used for optical communication systems. In particular, the invention relates to photodetectors that can detect very high power and very high speed optical signal with a high degree of linearity. Such photodetectors have numerous applications in optical signal transmission and processing systems. In particular, one application for such photodetectors is in low-noise, high-gain, and high-linearity analog optical RF links used in systems, such as fiber-remote phased array antenna systems.

Photodetectors are used to convert optical signals including DC and AC signal components to DC and AC photocurrents. Photodetector responses are generally characterized by their responsivity, which is the ratio of the photodetector's output photocurrent to the photodetecotor's input optical power. The responsivity of a photodetector can be saturated at high photocurrent densities because of high temperature effects and because of the screening effect. The detector's responsivity also has a roll-off at high AC frequency due to the carrier transit time limit and due to the equivalent RC time constant limit. The linearity of a photodetector's responsivity is limited by the saturation power and by the interaction between the optical mode index and the carrier density variation inside the optical active waveguide.

The present invention relates to methods and apparatus for high power, high-speed, and high-linearity light detection that physically decouple the optical distribution section of the photodetector from the optical detection section of the photodetector. One aspect of the present invention is the use of a non-absorption optical distribution waveguide or other optical distribution means to decouple the light propagation waveguide from the surface normal light detection device. The decoupling distributes the light along the detection device, thereby reducing the optical power density in order to avoid local saturation and/or detector damage. Consequently, the decoupling improves the saturation power, the frequency response, and the linearity of the photodetector.

Furthermore, the decoupling of the optical distribution section from the optical detection section of the photodetector allows the optical waveguide design parameters to be independent of the RF electrode design parameters. Consequently, the saturation power and the frequency response of the photodetector can be independently optimized. Thus, in photodetectors according to the present invention, both high saturation power and high frequency response can be simultaneously achieved.

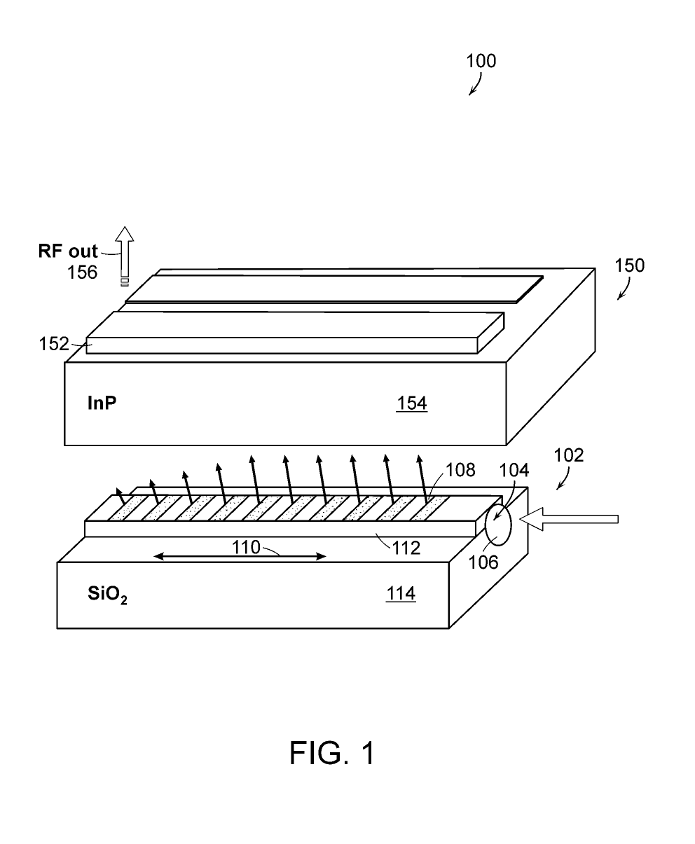

FIG. 1 is a diagram of one embodiment of a high-power, high-speed optical detector 100 that includes a separate optical distribution device 102 and a separate optical detection device 150 according to the present invention. The optical distribution device 102 includes an optical waveguide 104 having an optical input 106 that distributes the optical power along its length so that the optical power density is sufficiently low everywhere to prevent any local saturation and/or damage. In some embodiments, the optical power is distributed linearly along the optical waveguide 104. In other embodiments, the optical power is distributed non-linearly along the optical waveguide 104.

There are many possible embodiments of the optical distribution device 102. In the embodiment shown in FIG. 1, the optical distribution device 102 includes an optical waveguide grating coupler 108 that can be a Bragg grating or a photonic crystal grating. In various embodiments, the optical waveguide grating coupler 108 can be a uniform or a non-uniform grating that is coupled along the length 110 of the optical waveguide 104. Also, the optical waveguide grating coupler 108 can be a one-dimensional or a two-dimensional grating structure. In addition, the optical waveguide grating coupler 108 can be a strong or a weak grating coupler, depending on the grating design properties, such as the index difference, etching depth, duty cycle, and the filling factor. A coupling coefficient equal to 80.1% has been reported for a silica grating coupler with a 20 μm length. The term “coupling coefficient” is defined herein as the ratio of the output power to the input power. It is expected that a longer grating coupler could have an even better coupling coefficient.

The optical waveguide grating coupler 108 converts the guided light to a desired directional radiation mode. The surface-emitted light can be coupled out of the optical waveguide grating coupler 108 at a predetermined angle by properly selecting the grating properties, such as the period. For example, light can be coupled to the surface-normal direction by choosing the grating period equal to the ratio of the radiation wavelength to the effective refractive index of the propagation mode.

More particularly, the optical distribution device 102 shown in FIG. 1 includes an optical waveguide grating coupler 108 having an optical input 106. The optical input 106 can be coupled to an optical fiber or can be positioned to receive an optical signal from any optical source. In one embodiment, the optical input 106 is coupled to a low-loss silica channel or to a ridge optical waveguide that includes a high-refractive-index core layer 112 and a low-refractive-index surrounding material 114. The optical waveguide grating coupler 108 can also be formed with alternating layers of silicon and other low loss waveguide materials, such as SiO₂, to form Si/SiO₂ waveguides. Ultra-low loss waveguides with losses that are on the order of 0.2 dB/cm can be constructed with Si/SiO₂ waveguides. In addition, the optical waveguide grating coupler 108 can be formed a titanium diffused lithium niobate optical waveguide.

In many embodiments, the coupling loss of the optical waveguide grating coupler 108 is as low as 0.5 dB at the optical input 106. Silica is transparent to wavelengths around 1.55 μm. Therefore, there is no optical power dissipated in the optical waveguide at this wavelength. That is, the waveguide is considered to be a “cold” waveguide for the 1.55 μm light at any optical power. Consequently, the transmission properties of the optical waveguide grating coupler 108 are tolerant to large input power variations. The tolerance to large input power variations reduces nonlinearities in the detector and also enables the optical detector 100 to withstand high injection powers that are on the order of 1.5 Watts without causing any damage to the optical waveguide grating coupler 108.

The optical detection device 150 is separate from the optical distribution device 102 and is positioned to receive the optical power that is distributed along the length of the optical distribution device 102. In many embodiments, the optical detection device 150 is physically separate from the optical distribution device 102. In some embodiments, the optical detection device is bonded to the optical distribution device 102 by various means, such as by flip chip bonding. The optical detection device 150 converts the optical signal, which can be a very high-power, high-speed optical signal, into a DC and RF detected signal.

In one embodiment, the optical detection device 150 is a traveling wave photodetector. The traveling wave photodetector can be formed of a III-V compound material system. For example, the traveling wave photodetector can be formed of an InGaAs/InP material where an InGaAs absorption layer that forms a traveling wave transmission line 152 is grown on an InP substrate 154. The traveling wave transmission line 152 includes an RF output 156. One feature of the present invention is that the optical detection device 150 is decoupled from the optical waveguide grating coupler 108 in the optical distribution device 102. The decoupling allows the InGaAs absorption layer 152 in the optical detection device 150 to be optimized independently of the properties of the optical waveguide grating coupler 108.

In order for the optical detection device 150 to collect and transmit the RF signal efficiently, the traveling wave transmission lines 152 should have low-loss and the RF phase velocity should be closely matched to the optical group velocity. One feature of the photodetector of the present invention is that traveling wave transmission lines 152 can be optimized for low loss and velocity matching independently of the properties of the optical waveguide grating coupler 108 because the optical detection device 150 is decoupled from the optical distribution device 102.

In addition, using a separate optical detection device 150 according to the present invention allows the use of surface-normal detectors, such as partially depleted absorber (PDA) structures, which can detect relatively large optical powers. The optical detection device 150 can be illuminated from the top surface having the traveling wave transmission lines 152 or from the back surface of the substrate 154. The photodetector 100 illustrated in FIG. 1 is configured to have the optical detection device 150 illuminated from the back surface of the substrate 154. When the optical detection device 150 is illuminated from the back surface of the substrate 154, the traveling wave transmission lines 152 also functions as a reflection mirror, which doubles the absorption length, thereby increasing the optoelectronic responsivity and saturation power.

The present invention is, at least in part, the recognition that an optical detector can be constructed with physically separate optical distribution and optical detection devices and that such an optical detector allows the optical signal to be distributed along the optical distribution device in any desired profile. Unlike conventional traveling wave detectors where the optical distribution exhibits an exponential decay profile, the separate optical distribution device distributes the optical power to the optical detection device much more uniformly along its length. The uniform distribution of the optical power can prevent local saturation of the device that often occurs proximate to the input of the absorption waveguide in a conventional edge-coupled traveling wave photodetector.

In operation, an optical signal is coupled into the input 106 of the optical distribution device 102 from an optical fiber or from another optical source. The optical signal then propagates through the optical waveguide grating coupler 108 where the optical signal is converted from a longitudinal direction radiation mode to a surface-emitted radiation mode. The optical power of the optical signal in the surface-emitted radiation mode is distributed over the surface of the optical distribution device 102. The distributed optical signal illuminates the optical detection device 150 uniformly, or in a predetermined pattern, and is then converted to a traveling wave RF signal. The traveling wave RF signal is then propagated by the traveling wave electrodes 152 to the output 156.

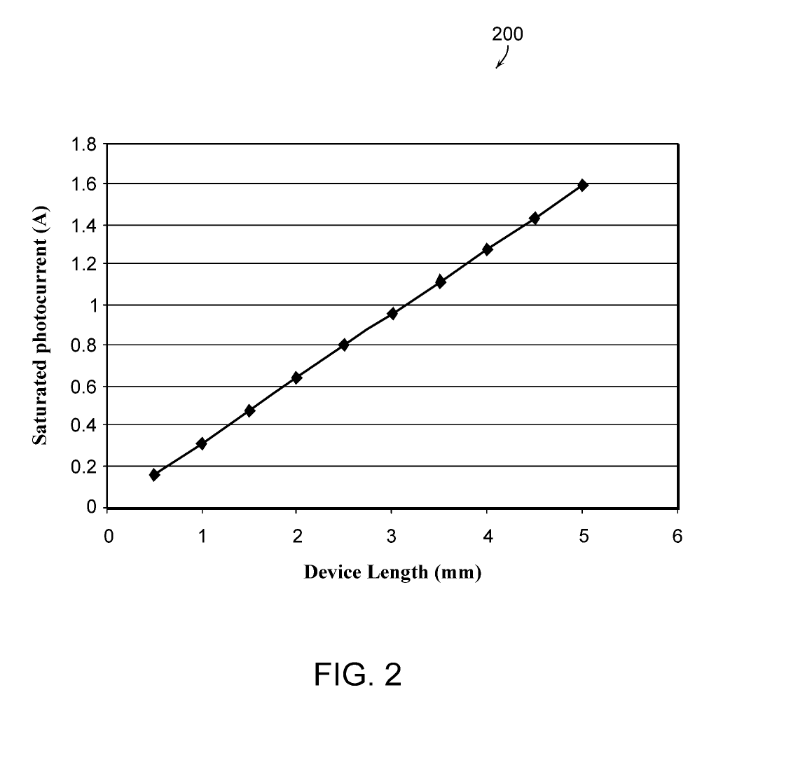

FIG. 2 is a graph 200 of calculated saturated photocurrent as a function of device length for a high-power, high-speed optical detector according to the present invention. The calculations were performed for a detection waveguide having a width that is equal to 5 μm. The calculated saturation photocurrent density was 0.0637 mA/μm². The calculations assume that the waveguide is uniformly illuminated. The graph 200 shows that the relationship between the device length and the saturated photocurrent is linear. The graph also indicates that more than 1 A of non-saturated photocurrent can be achieved with a device length that is longer than 3 mm.

### Equivalents

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, which may be made therein without departing from the spirit and scope of the invention.

What is claimed is:

1. A photodetector comprising:
a. an optical distribution device having an optical input that receives an input optical signal and an optical waveguide grating coupler, the optical waveguide grating coupler converting the input optical signal from a longitudinal direction radiation mode to a surface-emitted radiation mode that distributes the optical signal along a length the optical waveguide grating coupler and emits the distributed optical signal from the surface; and
b. an optical detector having an optical input that is positioned to receive the distributed optical signal emitted from the optical distribution device along a length the optical waveguide grating coupler, the optical detector generating a traveling wave RF signal, wherein the optical distribution device reduces an optical power density of the input optical signal, thereby avoiding local saturation and damage to the optical detector.

2. The photodetector of claim 1 wherein the surface-emitted radiation mode comprises a surface-normal direction radiation mode.

3. The photodetector of claim 1 wherein the optical distribution device and the optical detector are separate devices that are bonded together.

4. The photodetector of claim 1 wherein a grating pitch of the optical waveguide grating coupler is chosen to distribute the optical signal uniformly along the length the optical waveguide grating coupler.

5. The photodetector of claim 1 wherein a grating pitch of the optical waveguide grating coupler is chosen to distribute the optical signal along the length the optical waveguide grating coupler in a predetermined non-linear pattern.

6. The photodetector of claim 1 wherein a grating pitch of the optical waveguide grating coupler is chosen to increase at least one of saturation power, frequency response of the photodetector, and linearity of the photodetector.

7. The photodetector of claim 1 wherein a grating period of the optical waveguide grating coupler is equal to a ratio of the radiation wavelength to the effective refractive index of the propagation mode in the optical waveguide grating coupler.

8. The photodetector of claim 1 wherein the optical detector comprises a traveling wave optical detector.

9. The photodetector of claim 1 wherein the optical detector comprises an InGaAs/InP optical detector.

10. The photodetector of claim 1 wherein the optical waveguide grating coupler comprises a non-absorption optical distribution waveguide coupler.

11. The photodetector of claim 1 wherein the optical detector comprises a partially depleted absorber structure.

12. The photodetector of claim 1 wherein an RF phase velocity of the traveling wave RF signal is closely matched to an optical group velocity of the optical signal.

13. A method of detecting an optical signal, the method comprising:
a. propagating an optical signal through an optical waveguide grating coupler wherein the optical signal is converted from a longitudinal direction radiation mode to a surface-emitted radiation mode that distributes the optical signal along a length of the optical waveguide grating coupler; and
b. illuminating an optical detection device with the optical signal distributed over the length of the optical waveguide grating coupler, thereby generating a traveling wave RF signal.

14. The method of claim 13 wherein the illuminating the optical detection device with the distributed optical signal comprises uniformly illuminating the optical detection device.

15. The method of claim 13 wherein the surface-emitted radiation mode is in a surface-normal direction.

16. The method of claim 13 further comprising selecting a grating pitch of the optical waveguide grating coupler to distribute the optical signal uniformly along the length of the optical waveguide.

17. The method of claim 13 further comprising selecting a grating pitch of the optical waveguide grating coupler to distribute the optical signal along the length of the optical waveguide in a predetermined non-linear pattern.

18. The method of claim 13 further comprising selecting a grating pitch of the optical waveguide grating coupler to improve at least one of saturation power, frequency response of the photodetector, and linearity of the photodetector.

19. The method of claim 13 wherein an RF phase velocity of the traveling wave RF signal is closely matched to an optical group velocity of the optical signal.

20. A photodetector comprising:
a. an optical distribution means that transforms an input optical signal from a longitudinal direction radiation mode to a surface-emitted mode and that distributes the optical signal along a length of the optical distribution means; and
b. an optical detection means that generates a traveling wave RF signal from the optical signal distributed over the length of the optical distribution means.
